(19) United States
(12) Patent Application Publication
(10) Pub. No.: US 2026/0149089 A1
(43) Pub. Date: May 28, 2026

(54) THERMAL MANAGEMENT SYSTEM FOR VEHICLE

(71) Applicant: Hanon Systems, Daejeon (KR)

(72) Inventors: Sang Gu WOO, Daejeon (KR); Moo Joong KIM, Daejeon (KR); Min Sung KIM, Daejeon (KR)

(73) Assignee: Hanon Systems, Daejeon (KR)

(21) Appl. No.: 19/123,319

(22) PCT Filed: Dec. 15, 2023
(86) PCT No.: PCT/KR2023/020739

§ 371 Date: Apr. 22, 2025

(30) Foreign Application Priority Data
Mar. 10, 2023 (KR) 10-2023-0031633

(51) Int. Cl. H01M 10/663; B60H 1/00; B60H 1/32; H01M 10/613; H01M 10/625; H01M 10/6568

(52) U.S. Cl. CPC H01M 10/663; B60H 1/00278; B60H 1/32284; H01M 10/613; H01M 10/625; H01M 10/6568; B60H 2001/00307; H01M 2220/20

(57) ABSTRACT

A thermal management system for a vehicle is disclosed. The system includes a compressor, a condenser, a refrigerant branch part, a first refrigerant line branching off from the refrigerant branch part toward one side, provided with a first expansion valve and a first heat exchanger, and configured to allow a refrigerant to circulate therethrough, a second refrigerant line branching off from the refrigerant branch part toward the other side, provided with a second expansion valve and a second heat exchanger, and configured to allow a refrigerant to circulate therethrough, an internal heat exchanger configured to allow the refrigerant, which passes through the condenser and moves to the refrigerant branch part, and the refrigerant, which passes through the first heat exchanger or the second heat exchanger and moves to the compressor, to exchange heat with each other, and a bypass line connected to allow refrigerant to bypass the internal heat exchanger.

### TECHNICAL FIELD

The present invention relates to a thermal management system for a vehicle, and more particularly, to a thermal management system for a vehicle that manages heat of an electrical component and a battery in a vehicle while cooling or heating the vehicle.

### BACKGROUND ART

Recently, in the field of vehicles, electric vehicles have been in the limelight as solutions for implementing environmentally-friendly technologies and solving problems such as energy depletion.

Because the electric vehicle travels by using a motor that operates by receiving electric power from a battery or a fuel cell, the electric vehicle emits a small amount of carbon and causes low noise. In addition, because the electric vehicle uses a motor excellent in energy efficiency in comparison with an engine in the related art, the electric vehicle is environmentally-friendly.

The thermal management is important because the battery and the drive motor of the electric vehicle generate a large amount of heat during the operation. Further, the efficient battery usage time management is important because a large amount of time is required to recharge the battery.

In particular, because the drive motor and an inverter generate a relatively larger amount of heat in comparison with other electrical components such as the battery or a charger, the drive motor needs to be cooled to an appropriate temperature. To this end, it is necessary to improve cooling performance of a heat exchanger for cooling the drive motor.

In addition, because refrigerant pressure at an inflow side of a compressor is decreased by heat exchanger with a refrigerant in a heat pump mode of a thermal management system, the thermal management system cannot serve as a heat pump or performance and efficiency may deteriorate.

Accordingly, there is a need to solve the problem.

### DISCLOSURE

### Technical Problem

An object to be achieved by the present invention is to provide a thermal management system for a vehicle that is capable of efficiently managing heat of an electrical component and a battery in a vehicle while cooling or heating the vehicle.

Technical problems of the present invention are not limited to the aforementioned technical problems, and other technical problems, which are not mentioned above, may be clearly understood by those skilled in the art from the following descriptions.

### Technical Solution

A thermal management system for a vehicle according to an embodiment of the present invention may include: a compressor; a condenser; a refrigerant branch part; a first refrigerant line branching off from the refrigerant branch part toward one side, provided with a first expansion valve and a first heat exchanger, and configured to allow a refrigerant to circulate therethrough; a second refrigerant line branching off from the refrigerant branch part toward the other side, provided with a second expansion valve and a second heat exchanger, and configured to allow a refrigerant to circulate therethrough; an internal heat exchanger configured to allow the refrigerant, which passes through the condenser and moves to the refrigerant branch part, and the refrigerant, which passes through the first heat exchanger or the second heat exchanger and moves to the compressor, to exchange heat with each other; and a bypass line connected to allow the refrigerant having passed through the condenser to bypass the internal heat exchanger.

In particular, the thermal management system may further include: a branch valve disposed at an outlet side of the condenser, in which depending on an air conditioning mode, the branch valve allows the refrigerant to pass through the internal heat exchanger or allows the refrigerant to move to the bypass line and bypass the internal heat exchanger.

In particular, the thermal management system may further include: an accumulator configured to separate the refrigerant, which passes through the first heat exchanger or the second heat exchanger and moves to the compressor, into a gaseous refrigerant and a liquid refrigerant and supply the gaseous refrigerant to the compressor.

In particular, the accumulator may be integrated with the internal heat exchanger.

In particular, the thermal management system may further include: a coolant circulation line configured to circulate a coolant that exchanges heat with air or the refrigerant.

In particular, the coolant circulation line may include: a first coolant line configured to exchange heat with the refrigerant while passing through the first heat exchanger and provided with a cabin cooler and a first direction switching valve; a second coolant line provided with a second direction switching valve and a heater core configured to heat a vehicle interior by using the coolant having exchanged heat with the refrigerant while passing through the condenser; and a third coolant line provided with a third direction switching valve and a battery through which the coolant having exchanged heat with the refrigerant while passing through the second heat exchanger flows.

In particular, the thermal management system may further include: a fourth coolant line connected to the second direction switching valve and branching off from the third coolant line connected to an outlet side of the second heat exchanger; and a fifth coolant line configured to connect the first direction switching valve and the third direction switching valve.

In particular, a reservoir tank and an electrical component may be disposed in the fourth coolant line, and a fourth direction switching valve and a radiator may be disposed in the fifth coolant line.

In particular, the first direction switching valve may be connected to a first connection line branching off from the reservoir tank, the second direction switching valve may be connected to a second connection line branching off from the fifth coolant line, and the fourth direction switching valve may be connected to a third connection line branching off from the first coolant line.

In particular, pumps may be respectively disposed in the first to fourth coolant lines, and a coolant heater may be disposed in the third refrigerant line and selectively operates to heat the coolant depending on an operating mode.

In particular, the cabin cooler and the heater core may be installed in an air conditioning device, and a PTC heater may be further installed in the air conditioning device.

In a cooling mode, the branch valve may control the refrigerant so that the refrigerant moves along a first refrigerant line and passes through the internal heat exchanger.

In a heating mode, the branch valve may control the refrigerant so that the refrigerant moves to the bypass line and bypasses the internal heat exchanger.

### Advantageous Effects

According to the embodiment of the present invention, it is possible to provide the thermal management system for a vehicle that is capable of efficiently managing the heat of the electrical component and the battery in the vehicle while cooling or heating the vehicle.

The effects of the present invention are not limited to the aforementioned effects, and other effects, which are not mentioned above, will be clearly understood by those skilled in the art from the claims.

### DESCRIPTION OF DRAWINGS

FIG. 1 is a view schematically illustrating a structure of a thermal management system for a vehicle according to an embodiment of the present invention.

FIGS. 2A and 2B are views schematically illustrating an operating state in accordance with an operating mode of a refrigerant circulation line in the thermal management system for a vehicle in FIG. 1.

FIG. 3 is a view schematically illustrating another embodiment of the refrigerant circulation line.

FIG. 4 is a view illustrating an operation in a first air conditioning mode of the thermal management system for a vehicle.

FIG. 5 is a view illustrating an operation in a second air conditioning mode of the thermal management system for a vehicle.

FIG. 6 is a view illustrating an operation in a third air conditioning mode of the thermal management system for a vehicle.

FIG. 7 is a view illustrating an operation in a fourth air conditioning mode of the thermal management system for a vehicle.

FIG. 8 is a view illustrating an operation in a fifth air conditioning mode of the thermal management system for a vehicle.

FIG. 9 is a view illustrating an operation in a sixth air conditioning mode of the thermal management system for a vehicle.

FIG. 10 is a view illustrating an operation in a seventh air conditioning mode of the thermal management system for a vehicle.

FIG. 11 is a view illustrating an operation in an eighth air conditioning mode of the thermal management system for a vehicle.

### MODE FOR INVENTION

The present invention may be variously modified and may have various embodiments, and particular embodiments illustrated in the drawings will be described below. However, the description of the embodiments is not intended to limit the present invention to the particular embodiments, but it should be understood that the present invention is to cover all modifications, equivalents and alternatives falling within the spirit and technical scope of the present invention. The terms including ordinal numbers such as “first,” “second,” and the like may be used to describe various constituent elements, but the constituent elements are not limited by the terms. These terms are used only to distinguish one constituent element from another constituent element. For example, a second component may be named a first component, and similarly, the first component may also be named the second component, without departing from the scope of the present invention. The term “and/or” includes any and all combinations of a plurality of the related and listed items.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

In addition, in the description of the embodiments, the expression “one constituent element is provided or disposed above (on) or below (under) another constituent element” includes not only a case in which the two constituent elements are in direct contact with each other, but also a case in which one or more other constituent elements are (indirectly) provided or disposed between the two constituent elements. The expression “above (on) or below (under)” may mean a downward direction as well as an upward direction based on one constituent element.

The terminology used herein is used for the purpose of describing particular embodiments only and is not intended to limit the present invention. Singular expressions include plural expressions unless clearly described as different meanings in the context. The terms “comprises,” “comprising,” “includes,” “including,” “containing,” “has,” “having” or other variations thereof are inclusive and therefore specify the presence of stated features, integers, steps, operations, elements, components, and/or combinations thereof, but do not preclude the presence or addition of one or more other features, integers, steps, operations, elements, components, and/or combinations thereof.

Unless otherwise defined, all terms used herein, including technical or scientific terms, have the same meaning as commonly understood by those skilled in the art to which the present invention pertains. The terms such as those defined in a commonly used dictionary should be interpreted as having meanings consistent with meanings in the context of related technologies and should not be interpreted as ideal or excessively formal meanings unless explicitly defined in the present application.

Hereinafter, embodiments will be described in detail with reference to the accompanying drawings. The same or corresponding constituent elements are assigned with the same reference numerals regardless of reference numerals, and the repetitive description thereof will be omitted.

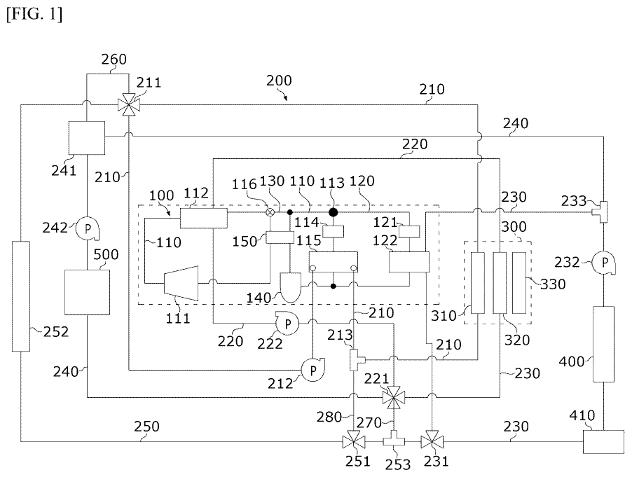

FIG. 1 schematically illustrates a structure of a thermal management system for a vehicle according to an embodiment of the present invention.

With reference to the drawings, the thermal management system for a vehicle according to the embodiment of the present invention may include a refrigerant circulation line 100 through which a refrigerant circulates, and a coolant circulation line 200 through which a coolant circulates.

The refrigerant circulation line 100 may include a compressor 111, a condenser 112, a refrigerant branch part 113, a first refrigerant line 110 branching off from the refrigerant branch part 113 toward one side and passing through a first expansion valve 114 and a first heat exchanger 115, a second refrigerant line 120 branching off from the refrigerant branch part 113 toward the other side and passing through a second expansion valve 121 and a second heat exchanger 122, a bypass line 130, an accumulator 140, and an internal heat exchanger 150.

The compressor 111, the condenser 112, the refrigerant branch part 113, the first expansion valve 114, and the first heat exchanger 115 may be disposed in the first refrigerant line 110.

The compressor 111 operates by receiving power from an engine (internal combustion engine) or a motor. The compressor may suck the refrigerant, compress the refrigerant into a high-temperature, high-pressure gaseous refrigerant, and then discharge the refrigerant to the condenser 112.

The condenser 112 serves to condense the refrigerant into a liquid refrigerant by allowing the refrigerant, which is discharged from the compressor 111, to exchange heat with the coolant in the coolant circulation line to be described below, and the condenser 112 serves to transmit the refrigerant to the first heat exchanger 115 and the second heat exchanger 122. In the embodiment, a water-cooled condenser may be used as the condenser 112.

The refrigerant branch part 113 may be disposed rearward of an outlet side of the condenser 112 based on a flow direction of the refrigerant. Two lines may branch off from the refrigerant branch part 113, one line may be the first refrigerant line 110 connected to the first heat exchanger 115, and the other line may be the second refrigerant line 120 connected to the second heat exchanger 122.

The first expansion valve 114 may branch off from the refrigerant branch part 113 and serve to throttle the refrigerant moving along the first refrigerant line 110 or block the flow of the refrigerant. The first expansion valve 114 may be disposed at an inlet side of the first heat exchanger 115 based on the flow direction of the refrigerant.

The first heat exchanger 115 may be disposed rearward of the first expansion valve 114 based on the flow direction of the refrigerant, and the refrigerant may exchange heat with the coolant while passing through the first heat exchanger 115. In the embodiment, a water-cooled evaporator may be used as the first heat exchanger 115, and the first heat exchanger 115 may be provided outside an air conditioning device of a vehicle.

The second refrigerant line 120, together with the first refrigerant line 110, may branch off from the refrigerant branch part 113, and the second expansion valve 121 and the second heat exchanger 122 may be disposed in the second refrigerant line 120.

The second expansion valve 121 may branch off from the refrigerant branch part 113 and serve to throttle the refrigerant moving along the second refrigerant line 120 or block the flow of the refrigerant. The second expansion valve 121 may be disposed at an inlet side of the second heat exchanger 122 based on the flow direction of the refrigerant.

The second heat exchanger 122 may be disposed rearward of the first expansion valve 121 based on the flow direction of the refrigerant, and a low-temperature, low-pressure refrigerant discharged from the second expansion valve 121 may be supplied to the second heat exchanger 122 and exchange heat with the coolant in the coolant circulation line. In the embodiment, a chiller may be used as the second heat exchanger 122.

As described above, the first expansion valve 114 and the first heat exchanger 115 may constitute one set, the second expansion valve 121 and the second heat exchanger 122 may constitute another set, and the two sets may be configured in parallel in the refrigerant circulation line. Further, at the rear sides of the first and second heat exchangers 115 and 122 based on the flow direction of the refrigerant, the second refrigerant line 120 may merge with the first refrigerant line 110 to define a single refrigerant line.

The accumulator 140 may be disposed at an inlet side of the compressor 111 in the first refrigerant line 110, and the refrigerant, which passes through the first heat exchanger 115 and/or the second heat exchanger 122 and moves to the compressor 111, may be introduced into the accumulator 140. The accumulator 140 may separate a liquid refrigerant and a gaseous refrigerant and supply only the gaseous refrigerant to the compressor 111.

The internal heat exchanger 150 may be disposed in the first refrigerant line 110.

The internal heat exchanger 150 may allow the refrigerant, which passes through the condenser 112 and moves to the refrigerant branch part 113, and the refrigerant, which passes through the first heat exchanger 115 or the second heat exchanger 122 and moves back to the compressor 111, to exchange heat with each other. Therefore, before the refrigerant is introduced into the first expansion valve 114 or the second expansion valve 121, the refrigerant may be further cooled by the internal heat exchanger 150, thereby improving cooling performance implemented by the first heat exchanger 115 and improving efficiency of the cooling system.

The bypass line 130 may be connected to the first refrigerant line 110 in parallel so that the refrigerant having passed through the condenser 112 bypasses the internal heat exchanger 150. That is, the bypass line 130 may be disposed in parallel with a section of the first refrigerant line 110 that passes through the internal heat exchanger 150.

As illustrated in the drawings, one end of the bypass line 130 may be connected to a branch valve 116 disposed at an outlet side of the condenser 112 in the first refrigerant line 110, and the other end of the bypass line 130 may be connected between the internal heat exchanger 150 and the refrigerant branch part 113, such that the refrigerant discharged from the condenser 112 may selectively pass through the internal heat exchanger 150 or the bypass line 130. Further, depending on the air conditioning mode, under the control of the branch valve 116, the refrigerant may move to the first refrigerant line 110 and pass through the internal heat exchanger 150, or the refrigerant may move to the bypass line 130 and bypass the internal heat exchanger 150.

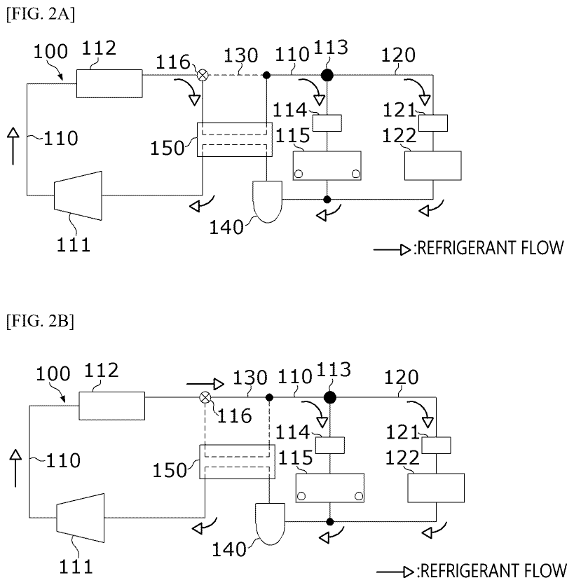

That is, as illustrated in FIG. 2A, the refrigerant having passed through the condenser 112 in a cooling mode may be controlled by the branch valve 116 to move along the first refrigerant line 110 and pass through the internal heat exchanger 150.

In addition, as illustrated in FIG. 2B, the refrigerant having passed through the condenser 112 in a heating mode may be controlled by the branch valve 116 to move along the bypass line 130 and bypass the internal heat exchanger 150.

As described above, the refrigerant may pass through the internal heat exchanger 150 in the cooling mode, and the condensed refrigerant may be supercooled while passing through the internal heat exchanger 150, thereby improving the cooling performance.

In addition, the refrigerant may bypass the internal heat exchanger 150 in the heating mode, which prevents a temperature of the refrigerant introduced into the compressor 111 from becoming high. That is, when the temperature of the refrigerant introduced into the compressor 111 becomes high, a flow rate of the refrigerant decreases, which degrades the heating performance. Therefore, in the heating mode, the refrigerant is controlled to bypass the internal heat exchanger 150, which may improve the heating performance.

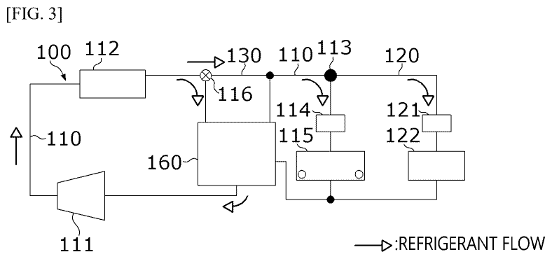

FIG. 3 schematically illustrates another embodiment of the refrigerant circulation line.

The refrigerant circulation line 100 may include the compressor 111, the condenser 112, the refrigerant branch part 113, the first refrigerant line 110 branching off from the refrigerant branch part 113 toward one side and passing through the first expansion valve 114 and the first heat exchanger 115, the second refrigerant line 120 branching off from the refrigerant branch part 113 toward the other side and passing through the second expansion valve 121 and the second heat exchanger 122, the bypass line 130, and an internal heat exchanger 160.

In the present embodiment, the internal heat exchanger 160 may be configured such that the internal heat exchanger 150 and the accumulator 140 according to the embodiment in FIG. 2 are integrated. That is, there is a difference in that in the embodiment in FIG. 2, the internal heat exchanger 150 and the accumulator 140 are provided as separate components separated from each other, whereas in the present embodiment, the internal heat exchanger 150 and the accumulator 140 are integrated and provided as a single component.

Therefore, depending on the air conditioning mode, under the control of the branch valve 116, the refrigerant may move to the first refrigerant line 110 and pass through the internal heat exchanger 160, or the refrigerant may move to the bypass line 130 and bypass the internal heat exchanger 160.

Further, the refrigerant may be introduced into the internal heat exchanger 160 and divided into a liquid refrigerant and a gaseous refrigerant. In the internal heat exchanger 160, the gaseous refrigerant may exchange heat with the refrigerant that passes through the condenser 112 and moves to the refrigerant branch part 113. Further, the gaseous refrigerant, which has performed the heat exchange, may be supplied back to the compressor 111 and circulated.

Hereinafter, the configuration in which the internal heat exchanger 150 and the accumulator 140 are provided as separate components separated from each other, as illustrated in FIG. 2, will be described.

The coolant circulation line 200 may be configured to circulate the coolant that exchanges heat with air or the refrigerant in the refrigerant circulation line 100.

With reference to the drawings, the coolant circulation line 200 may include a first coolant line 210 configured to exchange heat with the refrigerant while passing through the first heat exchanger 115 and provided with a cabin cooler 310 and a first direction switching valve 211, a second coolant line 220 provided with a second direction switching valve 221 and a heater core 320 configured to heat a vehicle interior by using the coolant having exchanged heat with the refrigerant while passing through the condenser 112, a third coolant line 230 provided with a third direction switching valve 231 and a battery 400 through which the coolant having exchanged heat with the refrigerant while passing through the second heat exchanger 122 flows, a fourth coolant line 240 branching off from the third coolant line 230 connected to an outlet side of the second heat exchanger 122, the fourth coolant line 240 being connected to the second direction switching valve 221, and a fifth coolant line 250 configured to connect the first direction switching valve 211 and the second direction switching valve 221. In addition, the coolant circulation line may further include a first connection line 260, a second connection line 270, and a third connection line 280.

The first coolant line 210 may be configured such that the coolant moving along the inside of the first coolant line 210 exchanges heat with the refrigerant while passing through the first heat exchanger 115. The cabin cooler 310 and the first direction switching valve 211 may be disposed in the first coolant line 210.

The cabin cooler 310 may serve as an air-cooled first heat exchanger, and the coolant having exchanged heat with the refrigerant passing through the first heat exchanger 115 may pass through the cabin cooler 310. The cabin cooler 310 may be installed in an air conditioning device 300 of the vehicle. Air, which is allowed to flow by a non-illustrated air blower, may be cooled by the coolant while passing through the cabin cooler 310 and supplied to the vehicle interior, such that the air may be used to cool the vehicle interior.

The first direction switching valve 211 may be disposed between the cabin cooler 310 and the first heat exchanger 115 and configured to be selectively connected to or disconnected from the fifth coolant line 250 to be described below. In addition, the fourth coolant line 240 and the fifth coolant line 250 may be selectively connected or disconnected. In the embodiment, the first direction switching valve 211 may include a 4-way valve.

A first pump 212 may be provided in the first coolant line 210 to circulate the coolant. The first pump 212 serves to pump the coolant so that the coolant circulates along the first coolant line 210. In the embodiment, the first pump 212 may be provided between the first direction switching valve 211 and the first heat exchanger 115 and disposed at an inlet side of the first heat exchanger 115.

The second coolant line 220 may be configured such that the coolant moving along the inside of the second coolant line 220 exchanges heat with the refrigerant while passing through the condenser 112. The heater core 320 and the second direction switching valve 221 may be disposed in the second coolant line 220.

The heater core 320 may be installed in the air conditioning device 300 of the vehicle. The air flowing by the air blower may be heated while passing through the heater core 320, supplied to the vehicle interior, and used to heat the vehicle interior. The heater core 320 may be disposed at a rear side, i.e., an outlet side of the condenser 112 based on a flow direction of the coolant.

The second direction switching valve 221 may be disposed between the condenser 112 and the heater core 320 and configured to be selectively connected to or disconnected from the fourth coolant line 240 to be described below. In addition, the second coolant line 220, the fourth coolant line 240, and the fifth coolant line 250 may be selectively connected or disconnected. In the embodiment, the second direction switching valve 221 may include a 4-way valve.

A second pump 222 may be provided in the second coolant line 220 to circulate the coolant. The second pump 222 serves to pump the coolant so that the coolant circulates along the second coolant line 220. In the embodiment, the second pump 222 may be provided between the second direction switching valve 221 and the condenser 112 and disposed at an inlet side of the condenser 112 based on the flow direction of the coolant.

As illustrated in the drawings, a positive temperature coefficient (PTC) heater 330 may be further installed in the air conditioning device 300 of the vehicle. The PTC heater 330, together with the heater core 320, is disposed in the air conditioning device 300 and used as a means for heating air. The PTC heater 330 may be used as a means for raising a temperature in case that a sufficient temperature required for vehicle air conditioning is not made by the heater core 320.

The third coolant line 230 may be configured such that the coolant moving along the inside of the third coolant line 230 exchanges heat with the refrigerant while passing through the second heat exchanger 122. The battery 400, the third direction switching valve 231, and a third pump 232 may be disposed in the third coolant line 230.

The battery 400 serves as a power source for the vehicle. The battery 400 may serve as a driving source for various types of electrical components 500 in the vehicle. Alternatively, the battery 400 may be connected to a fuel cell and serve to store electricity. Alternatively, the battery 400 may serve to store electricity supplied from the outside.

The third direction switching valve 231 may be disposed between the second heat exchanger 122 and the battery 400 and configured to be selectively connected to or disconnected from the fifth coolant line 250 to be described below. In the embodiment, the third direction switching valve 231 may include a 3-way valve.

The third pump 232 may serve to pump the coolant so that the coolant circulates along the third coolant line 230. In the embodiment, the third pump 232 may be provided between the second heat exchanger 122 and the battery 400 and disposed at an outlet side of the second heat exchanger 122 based on the flow direction of the coolant.

In addition, a coolant heater 410 may be disposed in the third coolant line 230 and heat the coolant. Depending on the operating mode, the coolant heater 410 may selectively operate to heat the coolant moving along the third coolant line 230. In the embodiment, in the heating mode, the coolant heater 410 may operate to heat the coolant, and the coolant heater 410 may be disposed between the battery 400 and the third direction switching valve 231.

The fourth coolant line 240 may be connected to the second coolant line 220 and the third coolant line 230 and configured such that the coolant moving along the inside of the fourth coolant line 240 circulates through the second coolant line 220 and the third coolant line 230.

Specifically, the fourth coolant line 240 branches off from the third coolant line 230 connected to the outlet side of the second heat exchanger 122, and the fourth coolant line 240 is connected to the second direction switching valve 221. One end of the fourth coolant line 240 may be connected to a second branch valve 233 disposed between the second heat exchanger 122 and the third pump 232 in the third coolant line 230, and the other end of the fourth coolant line 240 may be connected to the second direction switching valve 221. That is, the fourth coolant line 240 may be connected to the third coolant line 230 through the second branch valve 233 and connected to the second coolant line 220 through the second direction switching valve 221.

A reservoir tank 241, the electrical component 500, and a fourth pump 242 may be disposed in the fourth coolant line 240.

The reservoir tank 241 may serve to store the coolant and supplement the coolant in the coolant circulation line 200.

The electrical component 500 may include a drive motor, an inverter, a charger (on board charger (OBC)), or the like and be cooled by the coolant. In the embodiment, the electrical component 500 may be disposed forward of an outlet side of the reservoir tank 241 based on the flow direction of the coolant.

The fourth pump 242 may serve to pump the coolant so that the coolant circulates along the fourth coolant line 240. In the embodiment, the fourth pump 242 may be disposed between the reservoir tank 241 and the electrical component 500.

The fifth coolant line 250 may be connected to the first coolant line 210 and the third coolant line 230 and configured such that the coolant moving along the inside of the fifth coolant line 250 circulates through the first coolant line 210 and the third coolant line 230. A radiator 252 and a fourth direction switching valve 251 may be disposed in the fifth coolant line 250.

The radiator 252 may be a radiator that cools the coolant having exchanged heat with the electrical component 500 or the battery 400, and the radiator 252 may be cooled by a cooling fan (not illustrated) in an air-cooled manner. Further, the fourth direction switching valve 251 may include a 3-way valve.

As illustrated in the drawings, one end of the fifth coolant line 250 may be connected to the first direction switching valve 211, and the other end of the fifth coolant line 250 may be connected to the third direction switching valve 231. That is, the fifth coolant line 250 may be connected to the first coolant line 210 through the first direction switching valve 211 and connected to the third coolant line 230 through the third direction switching valve 231.

In addition, the fifth coolant line 250 may be connected to the fourth coolant line 240 through the first connection line 260 branching off from the reservoir tank 241 and connected to the first direction switching valve 211. In this case, the first coolant line 210 may also be connected to the fourth coolant line 240 through the first connection line 260 in the first direction switching valve 211.

In addition, the fifth coolant line 250 may be connected to the fourth coolant line 240 and the second coolant line 220 through the second connection line 270 connected to the second direction switching valve 221 and branching off from a third branch valve 253 provided in the fifth coolant line 250. In this case, the third coolant line 230 connected to the fifth coolant line 250 through the third direction switching valve 231 may also be connected to the second coolant line 220 and the fourth coolant line 240. In the embodiment, the third branch valve 253 may be disposed between the third direction switching valve 231 and the fourth direction switching valve 251.

In addition, the fifth coolant line 250 may be connected to the first coolant line 210 through the third connection line 280 connected to the fourth direction switching valve 251 and branching off from a first branch valve 213 provided in the first coolant line 210.

As described above, the first to fifth coolant lines 210, 220, 230, 240, and 250 are connected to one another through the first to fourth direction switching valves 211, 221, 231, and 251 and the first to third connection lines 260, 270, and 280 and configured such that the coolant circulates, which may efficiently manage the heat of the electrical component 500 and the battery 400 in the vehicle while cooling or heating the vehicle. In addition, in the case of the vehicle to which the high-performance, high-capacity drive motor is applied, the performance in cooling the drive motor may be improved. Further, the waste heat of the electrical component 500 and the battery 400 may be utilized.

Hereinafter, operations of the above-mentioned thermal management system according to the embodiment of the present invention in accordance with the air conditioning modes will be described.

### 1. First Air Conditioning Mode

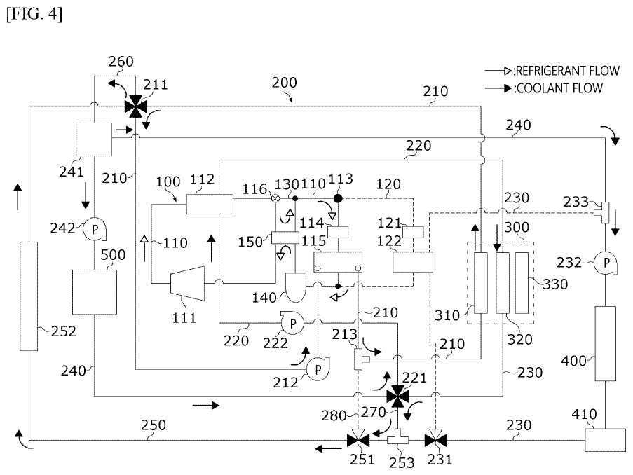

FIG. 4 is a view illustrating an operation in the first air conditioning mode.

With reference to FIG. 4, the first air conditioning mode refers to a mode in the vehicle interior is cooled and the battery 400 is cooled by using the radiator 252.

In the refrigerant circulation line 100, the compressor 111 operates, and the high-temperature, high-pressure refrigerant is discharged from the compressor 111. Further, the refrigerant, which is discharged from the compressor 111 and moves along the first refrigerant line 110, is cooled while exchanging heat with the coolant in the condenser 112. Next, the refrigerant cooled and condensed in the condenser 112 is expanded while passing through the internal heat exchanger 150 and then being throttled by the first expansion valve 114, and then the expanded refrigerant exchanges heat with the coolant while passing through the first heat exchanger 115. In this case, the bypass line 130 is blocked by the branch valve 116 so that the refrigerant does not flow. Further, the flow of the refrigerant through the second refrigerant line 120 may be blocked in the state in which the second expansion valve 121 is closed.

The refrigerant evaporated in the first heat exchanger 115 passes through the internal heat exchanger 150 via the accumulator 140, exchanges heat with the refrigerant before being introduced into the first expansion valve 114, and then is introduced back into the compressor 111. Further, the refrigerant circulates along the first refrigerant line 110 as the above-mentioned process is repeated.

Meanwhile, the coolant in the coolant circulation line 200 is circulated by the operations of the first pump 212, the second pump 222, the third pump 232, and the fourth pump 242. Further, the refrigerant passing through the condenser 112 and the first heat exchanger 115, the electrical component 500, and the battery 400 may be cooled by the circulating coolant, and the heated coolant may be cooled while exchanging heat with outside air in the radiator 252.

In this case, the first direction switching valve 211 may be adjusted in the direction in which the first direction switching valve 211 branches off from the first coolant line 210 and connects the fourth coolant line 240 and the fifth coolant line 250. In addition, the second direction switching valve 221 may be adjusted in the direction in which the second direction switching valve 221 connects the second coolant line 220 to the fourth coolant line 240 and connects the second coolant line 220 to the fifth coolant line 250. In addition, the third direction switching valve 231 may be adjusted in the direction in which the third direction switching valve 231 connects the third coolant line 230 and the fifth coolant line 250, and the fourth direction switching valve 251 may be adjusted to be disconnected from the first coolant line 210.

More specifically, the coolant may flow as the left sides and the upper sides of the first and second direction switching valves 211 and 221 are connected to one another, and the coolant may flow as the right sides and the lower sides of the first and second direction switching valves 211 and 221 are connected to one another. Further, the coolant may flow as the left sides and the right sides of the third and fourth direction switching valves 231 and 251 are connected to one another, and the upper sides of the third and fourth direction switching valves 231 and 251 may be disconnected.

Therefore, the coolant may be introduced into the reservoir tank 241 from the radiator 252 through the first direction switching valve 211 and the first connection line 260. A part of the coolant branching off from the reservoir tank 241 toward one side may move along the fourth coolant line 240 and be introduced into the third coolant line 230 from the second branch valve and then introduced into the fifth coolant line 250 from the third direction switching valve 231 via the battery 400 and the coolant heater 410. Further, the remaining part of the coolant branching off from the reservoir tank 241 toward the other side may be introduced into the second coolant line 220 from the second direction switching valve 221 via the electrical component 500, introduced from the second direction switching valve 221 via the condenser 112 and the heater core 320, and then introduced into the fifth coolant line 250 via the second connection line 270 and the third branch valve 253. Further, the coolant, which merges into the fifth coolant line 250, is introduced back into the radiator 252 via the fourth direction switching valve 251, such that the cycle for circulating the coolant is repeated.

In addition, the coolant is introduced back into the cabin cooler 310 sequentially via the first direction switching valve 211, the first heat exchanger 115, and the first branch valve 213 from the cabin cooler 310 along the first coolant line 210, such that the cycle for circulating the coolant in a closed loop structure is repeated.

Therefore, the battery 400 and the electrical component 500 may be cooled by the heat exchange with the outside air. Further, the cabin cooler 310 may cool the vehicle interior as the coolant circulating in the closed loop structure along the first coolant line 210 is cooled by the refrigerant.

### 2. Second Air Conditioning Mode

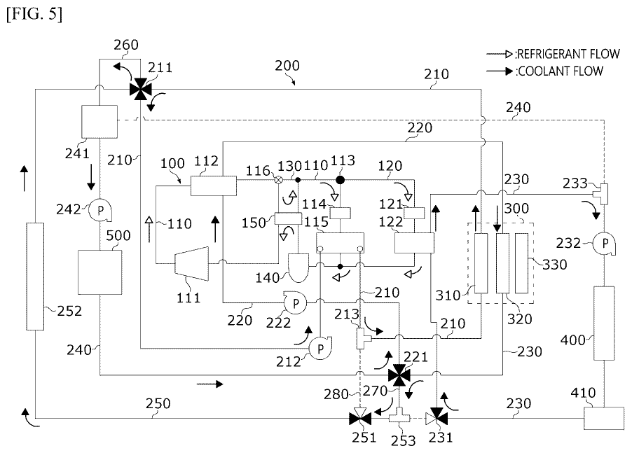

FIG. 5 is a view illustrating an operation in the second air conditioning mode.

With reference to FIG. 5, the second air conditioning mode refers to a mode in which the vehicle interior is cooled and the battery 400 is cooled by using the second heat exchanger 122.

In the refrigerant circulation line 100, the compressor 111 operates, and the high-temperature, high-pressure refrigerant is discharged from the compressor 111. Further, the refrigerant, which is discharged from the compressor 111 and moves along the first refrigerant line 110, is cooled while exchanging heat with the coolant in the condenser 112. Next, the refrigerant cooled and condensed in the condenser 112 branches off from the refrigerant branch part 113 after passing through the internal heat exchanger 150. Thereafter, a part of the refrigerant is expanded while being throttled by the first expansion valve 114, and then the expanded refrigerant exchanges heat with the coolant while passing through the first heat exchanger 115. In this case, the bypass line 130 is blocked by the branch valve 116 so that the refrigerant does not flow. The refrigerant evaporated in the first heat exchanger 115 passes through the internal heat exchanger 150 via the accumulator 140, exchanges heat with the refrigerant before being introduced into the first expansion valve 114, and then is introduced back into the compressor.

In addition, the remaining part of the refrigerant branching off from the refrigerant branch part 113 moves along the second refrigerant line 120 and is expanded while being throttled by the second expansion valve 121. Thereafter, the expanded refrigerant may exchange heat with the coolant while passing through the second heat exchanger 122 and cool the coolant while being evaporated. Further, the refrigerant evaporated in the second heat exchanger 122 passes through the internal heat exchanger 150 via the accumulator 140, exchanges heat with the refrigerant before being introduced into the second expansion valve 121, and then is introduced back into the compressor 111.

As described above, the refrigerant having passed through the first heat exchanger 115 and the refrigerant having passed through the second heat exchanger 122 merge with each other in the accumulator 140, pass through the internal heat exchanger 150, and then flow into the compressor 111. The refrigerant circulates as the above-mentioned process is repeated.

Meanwhile, the coolant in the coolant circulation line 200 is circulated by the operations of the first pump 212, the second pump 222, the third pump 232, and the fourth pump 242. Further, the refrigerant passing through the condenser 112, the first heat exchanger 115, and the second heat exchanger 122, the electrical component 500, and the battery 400 may be cooled by the circulating coolant, and the heated coolant may be cooled while exchanging heat with outside air in the radiator 252.

In this case, the first direction switching valve 211 may be adjusted in the direction in which the first direction switching valve 211 branches off from the first coolant line 210 and connects the fourth coolant line 240 and the fifth coolant line 250. In addition, the second direction switching valve 221 may be adjusted in the direction in which the second direction switching valve 221 connects the second coolant line 220 to the fourth coolant line 240 and connects the second coolant line 220 to the fifth coolant line 250. In addition, the third direction switching valve 231 may be adjusted in the direction in which the third direction switching valve 231 disconnects the third coolant line 230 and the fifth coolant line 250, and the fourth direction switching valve 251 may be adjusted to be disconnected from the first coolant line 210.

More specifically, the coolant may flow as the left sides and the upper sides of the first and second direction switching valves 211 and 221 are connected to one another, and the coolant may flow as the right sides and the lower sides of the first and second direction switching valves 211 and 221 are connected to one another. The coolant may flow as the right side and the upper side of the third direction switching valve 231 are connected to each other, and the left side of the third direction switching valve 231 may be disconnected. Further, the coolant may flow as the left side and the right side of the fourth direction switching valve 251 are connected to each other, and the upper side of the fourth direction switching valve 251 may be disconnected.

Therefore, the coolant may be introduced into the reservoir tank 241 from the radiator 252 via the first direction switching valve 211 and the first connection line 260. The coolant in the reservoir tank 241 may move along the fourth coolant line 240 and be introduced into the second coolant line 220 from the second direction switching valve 221 via the electrical component 500, introduced from the second direction switching valve 221 via the condenser 112 and the heater core 320, and then introduced into the fifth coolant line 250 via the second connection line 270 and the third branch valve 253. Further, the coolant in the fifth coolant line 250 is introduced back into the radiator 252 via the fourth direction switching valve 251, such that the cycle for circulating the coolant is repeated.

In addition, the coolant is introduced back into the cabin cooler 310 sequentially via the first direction switching valve 211, the first heat exchanger 115, and the first branch valve 213 from the cabin cooler 310 along the first coolant line 210, such that the cycle for circulating the coolant in a closed loop structure is repeated.

In addition, the coolant is introduced back into the second heat exchanger 122 sequentially via the second branch valve 233, the battery 400, the coolant heater 410, and the third direction switching valve 231 from the second heat exchanger 122 along the third coolant line 230, such that the cycle for circulating the coolant in the closed loop structure is repeated.

Therefore, the battery may be cooled as the coolant circulating in the closed loop structure along the third coolant line 230 exchanges heat with the refrigerant in the second heat exchanger 122. Further, the electrical component 500 may be cooled as the coolant exchanges heat with the outside air in the radiator 252. Further, the cabin cooler 310 may cool the vehicle interior as the coolant circulating in the closed loop structure along the first coolant line 210 is cooled by the refrigerant in the first heat exchanger 115.

### 3. Third Air Conditioning Mode

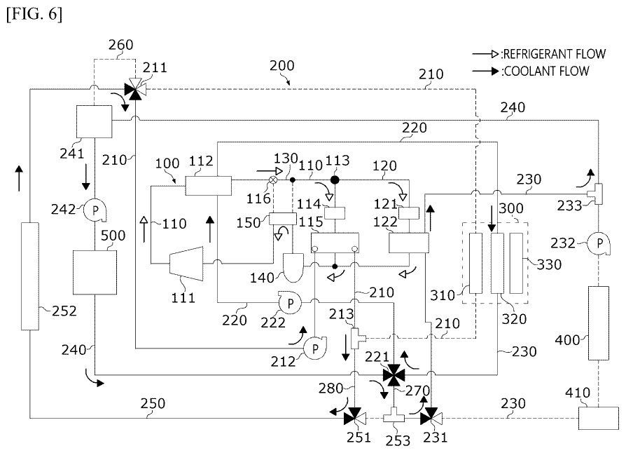

FIG. 6 is a view illustrating an operation in the third air conditioning mode.

With reference to FIG. 6, the third air conditioning mode refers to a mode in which the vehicle interior is heated, heat of the outside air is absorbed, and waste heat of the electrical component 500 is absorbed by using the second heat exchanger 122.

In the refrigerant circulation line 100, the compressor 111 operates, and the high-temperature, high-pressure refrigerant is discharged from the compressor 111. Further, the refrigerant, which is discharged from the compressor 111 and moves along the first refrigerant line 110, is cooled while exchanging heat with the coolant in the condenser 112. Next, the refrigerant cooled and condensed in the condenser 112 moves to the refrigerant branch part 113 along the bypass line 130. Thereafter, a part of the refrigerant is expanded while being throttled by the first expansion valve 114, and then the expanded refrigerant exchanges heat with the coolant while passing through the first heat exchanger 115. In this case, the branch valve 116 allows the refrigerant to bypass the internal heat exchanger 150 without passing through the internal heat exchanger 150. The refrigerant evaporated in the first heat exchanger 115 is introduced back into the compressor 111 via the accumulator 140 and the internal heat exchanger 150. In this case, the refrigerant is introduced back into the compressor 111 without exchanging heat with the refrigerant before being introduced into the first expansion valve 114.

In addition, the remaining part of the refrigerant branching off from the refrigerant branch part 113 moves along the second refrigerant line 120 and is expanded while being throttled by the second expansion valve 121. Thereafter, the expanded refrigerant may exchange heat with the coolant while passing through the second heat exchanger 122 and cool the coolant while being evaporated. Further, the refrigerant evaporated in the second heat exchanger 122 is introduced back into the compressor 111 via the accumulator 140 and the internal heat exchanger 150.

As described above, the refrigerant having passed through the first heat exchanger 115 and the refrigerant having passed through the second heat exchanger 122 merge with each other in the accumulator 140, pass through the internal heat exchanger 150, and then flow into the compressor 111. The refrigerant circulates as the above-mentioned process is repeated.

Unlike the cooling mode, the refrigerants do not exchange heat with each other in the internal heat exchanger 150, such that a thermal loss of the refrigerant may be suppressed, which may improve the heating performance and efficiency.

Meanwhile, the coolant in the coolant circulation line 200 is circulated by the operations of the first pump 212, the second pump 222, and the fourth pump 242. Further, the circulating coolant may exchange heat with the electrical component 500 and the refrigerant passing through the condenser 112, the first heat exchanger 115, and the second heat exchanger 122, and the circulating coolant may exchange heat with the outside air in the radiator 252.

In this case, the first direction switching valve 211 may be adjusted in the direction in which the first direction switching valve 211 branches off from the fourth coolant line 240 and connects the first coolant line 210 and the fifth coolant line 250. In addition, the second direction switching valve 221 may be adjusted in the direction in which the second direction switching valve 221 branches off from the second coolant line 220 and connects the fourth coolant line 240 to the fifth coolant line 250. In addition, the third direction switching valve 231 may be adjusted in the direction in which the third direction switching valve 231 connects the third coolant line 230 and the fifth coolant line 250, and the fourth direction switching valve 251 may be adjusted in the direction in which the fourth direction switching valve 251 connects the first coolant line 210 and the fifth coolant line 250.

More specifically, the coolant may flow as the left side and the lower side of the first direction switching valve 211 are connected to each other, and the right side and the upper side of the first direction switching valve 211 may be disconnected. The coolant may flow as the left side and the lower side of the second direction switching valve 221 are connected to each other, and the coolant may flow as the right side and the upper side of the second direction switching valve 221 are connected to each other. The coolant may flow as the left sides and the upper sides of the third and fourth direction switching valves 231 and 251 are connected to one another, and the right sides of the third and fourth direction switching valves 231 and 251 may be disconnected.

Therefore, the coolant in the radiator 252 may move from the first direction switching valve 211 to the first coolant line 210, move to the third connection line 280 via the first heat exchanger 115 and the first branch valve, and flow into the fifth coolant line 250 from the fourth direction switching valve 251. Further, the coolant in the fifth coolant line 250 is introduced back into the radiator 252, such that the cycle for circulating the coolant is repeated.

In addition, the coolant is introduced into the second connection line 270 from the second direction switching valve 221 via the electrical component 500 from the reservoir tank 241 along the fourth coolant line 240, moved to the third direction switching valve 231 from the third branch valve 253 along the fifth coolant line 250, and introduced back into the reservoir tank 241 from the third direction switching valve 231 via the third coolant line 230, the second branch valve 233, and the fourth coolant line 240, such that the cycle for circulating the coolant is repeated.

In addition, the coolant is introduced back into the heater core 320 sequentially via the second direction switching valve 221 and the condenser 112 from the heater core 320 along the second coolant line 220, such that the cycle for circulating the coolant in the closed loop structure is repeated.

Therefore, the coolant exchanges heat with the air of the air conditioning device 300 while passing through the condenser 112 and the heater core 320, and the air is heated. The heated air may be supplied to the vehicle interior and heat the vehicle interior.

In addition, the first heat exchanger 115 is configured to absorb heat from the outside air through the radiator 252, and the second heat exchanger 122 is configured to recover and absorb waste heat of the electrical component 500. Therefore, the first heat exchanger 115 and the second heat exchanger 122 may absorb heat from the different heat sources, which may improve the heating performance.

### 4. Fourth Air Conditioning Mode

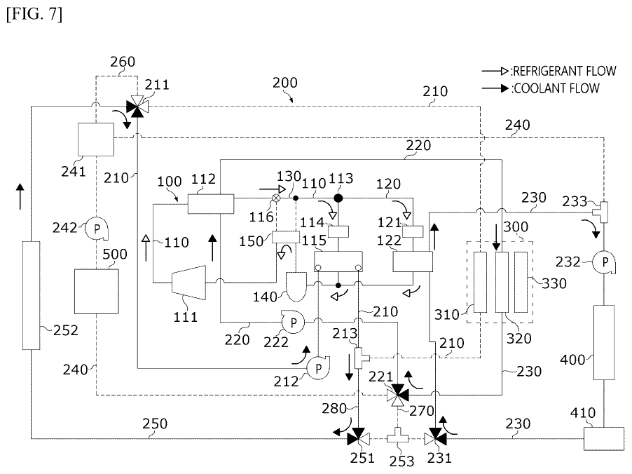

FIG. 7 is a view illustrating an operation in the fourth air conditioning mode.

With reference to FIG. 7, the fourth air conditioning mode refers to a mode in which the vehicle interior is heated, heat of the outside air is absorbed, and waste heat of the battery 400 is absorbed by using the second heat exchanger 122.

Because the operation of the refrigerant circulation line 100 in the fourth air conditioning mode is identical to that in the third air conditioning mode, a description thereof will be omitted.

The coolant in the coolant circulation line 200 is circulated by the operations of the first pump 212, the second pump 222, and the third pump 232. Further, the circulating coolant may exchange heat with the battery 400 and the refrigerant passing through the condenser 112, the first heat exchanger 115, and the second heat exchanger 122, and the circulating coolant may exchange heat with the outside air in the radiator 252.

In this case, the first direction switching valve 211 may be adjusted in the direction in which the first direction switching valve 211 branches off from the fourth coolant line 240 and connects the first coolant line 210 and the fifth coolant line 250. In addition, the second direction switching valve 221 may be adjusted in the direction in which the second direction switching valve 221 branches off from the fourth coolant line 240 and the fifth coolant line 250 and is disconnected from the fourth coolant line 240 and the fifth coolant line 250. In addition, the third direction switching valve 231 may be adjusted in the direction in which the third direction switching valve 231 is disconnected from the third coolant line 230 and the fifth coolant line 250, and the fourth direction switching valve 251 may be adjusted in the direction in which the fourth direction switching valve 251 connects the first coolant line 210 and the fifth coolant line 250.

More specifically, the coolant may flow as the left side and the lower side of the first direction switching valve 211 are connected to each other, and the right side and the upper side of the first direction switching valve 211 may be disconnected. The coolant may flow as the right side and the upper side of the second direction switching valve 221 are connected to each other, and the left side and the lower side of the second direction switching valve 221 may be disconnected. The coolant may flow as the right side and the upper side of the third direction switching valve 231 are connected to each other, and the left side of the third direction switching valve 231 may be disconnected. The coolant may flow as the left side and the upper side of the fourth direction switching valve 251 are connected to each other, and the right side of the fourth direction switching valve 251 may be disconnected.

Therefore, the coolant from the radiator 252 may move from the first direction switching valve 211 to the first coolant line 210, move to the third connection line 280 via the first heat exchanger 115 and the first branch valve 213, and flow into the fifth coolant line 250 from the fourth direction switching valve 251. Further, the coolant in the fifth coolant line 250 is introduced back into the radiator 252, such that the cycle for circulating the coolant is repeated.

In addition, the coolant is introduced back into the battery 400 sequentially via the battery 400, the coolant heater 410, the third direction switching valve 231, and the second heat exchanger 122 from the second branch valve 233 along the third coolant line 230, such that the cycle for circulating the coolant in the closed loop structure is repeated. In this case, the coolant heater 410 may selectively operate to heat the coolant.

In addition, the coolant is introduced back into the heater core 320 sequentially via the second direction switching valve 221 and the condenser 112 from the heater core 320 along the second coolant line 220, such that the cycle for circulating the coolant in the closed loop structure is repeated.

Therefore, the coolant exchanges heat with the air of the air conditioning device 300 while passing through the condenser 112 and the heater core 320, and the air is heated. The heated air may be supplied to the vehicle interior and heat the vehicle interior.

In addition, the first heat exchanger 115 is configured to absorb heat from the outside air through the radiator 252, and the second heat exchanger 122 is configured to recover and absorb waste heat of the battery 400. Therefore, the first heat exchanger 115 and the second heat exchanger 122 may absorb heat from the different heat sources, which may improve the heating performance.

### 5. Fifth Air Conditioning Mode

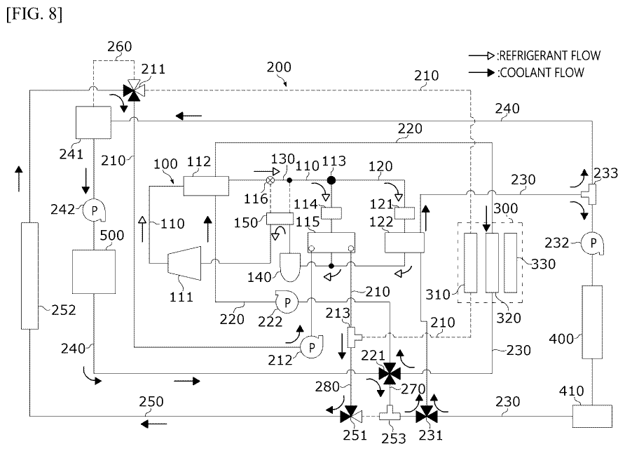

FIG. 8 is a view illustrating an operation in the fifth air conditioning mode.

With reference to FIG. 8, the fifth air conditioning mode refers to a mode in which the vehicle interior is heated, heat of the outside air is absorbed, and waste heat of the electrical component 500 and the battery 400 is absorbed by using the second heat exchanger 122.

Because the operation of the refrigerant circulation line 100 in the fifth air conditioning mode is identical to that in the third air conditioning mode, a description thereof will be omitted.

The coolant in the coolant circulation line 200 is circulated by the operations of the first pump 212, the second pump 222, the third pump 232, and the fourth pump 242. Further, the circulating coolant may exchange heat with the electrical component 500 and the battery 400 and the refrigerant passing through the condenser 112, the first heat exchanger 115, and the second heat exchanger 122, and the circulating coolant may exchange heat with the outside air in the radiator 252.

In this case, the first direction switching valve 211 may be adjusted in the direction in which the first direction switching valve 211 branches off from the fourth coolant line 240 and connects the first coolant line 210 and the fifth coolant line 250. In addition, the second direction switching valve 221 may be adjusted in the direction in which the second direction switching valve 221 branches off from the second coolant line 220 and connects the fourth coolant line 240 and the fifth coolant line 250. In addition, the third direction switching valve 231 may be adjusted in the direction in which the third direction switching valve 231 connects the third coolant line 230 and the fifth coolant line 250, and the fourth direction switching valve 251 may be adjusted in the direction in which the fourth direction switching valve 251 connects the first coolant line 210 and the fifth coolant line 250.

More specifically, the coolant may flow as the left side and the lower side of the first direction switching valve 211 are connected to each other, and the right side and the upper side of the first direction switching valve 211 may be disconnected. The coolant may flow as the right side and the upper side of the second direction switching valve 221 are connected to each other, and the coolant may flow as the left side and the lower side of the second direction switching valve 221 are connected to each other. The coolant may flow as the left side and the right side of the third direction switching valve 231 are connected to the upper side of the third direction switching valve 231. The coolant may flow as the left side and the upper side of the fourth direction switching valve 251 are connected to each other, and the right side of the fourth direction switching valve 251 may be disconnected.

Therefore, the coolant from the radiator 252 may move from the first direction switching valve 211 to the first coolant line 210, move to the third connection line 280 via the first heat exchanger 115 and the first branch valve 213, and flow into the fifth coolant line 250 from the fourth direction switching valve 251. Further, the coolant in the fifth coolant line 250 is introduced back into the radiator 252, such that the cycle for circulating the coolant is repeated.

In addition, the coolant may be introduced into the second connection line 270 from the second direction switching valve 221 via the reservoir tank 241 and the electrical component 500 along the fourth coolant line 240 and introduced into the third coolant line 230 via the third branch valve 253 and the third direction switching valve 231. A part of the coolant branching off from the second branch valve 233 toward one side via the second heat exchanger 122 may move along the fourth coolant line 240 and flow back into the reservoir tank 241. Further, the remaining part of the coolant branching off from the second branch valve 233 toward the other side may move along the third coolant line 230, flow back into the third direction switching valve 231 via the battery 400 and the coolant heater 410, and merge with the moving coolant in the third branch valve 253, such that the cycle for circulating the coolant in the closed loop structure is repeated. In this case, the coolant heater 410 may selectively operate to heat the coolant.

In addition, the coolant is introduced back into the heater core 320 sequentially via the second direction switching valve 221 and the condenser 112 from the heater core 320 along the second coolant line 220, such that the cycle for circulating the coolant in the closed loop structure is repeated.

Therefore, the coolant exchanges heat with the air of the air conditioning device 300 while passing through the condenser 112 and the heater core 320, and the air is heated. The heated air may be supplied to the vehicle interior and heat the vehicle interior.

In addition, the first heat exchanger 115 is configured to absorb heat from the outside air through the radiator 252, and the second heat exchanger 122 is configured to recover and absorb waste heat of the battery 400 and the electrical component 500 simultaneously. Therefore, the first heat exchanger 115 and the second heat exchanger 122 may absorb heat from the different heat sources, which may improve the heating performance.

### 6. Sixth Air Conditioning Mode

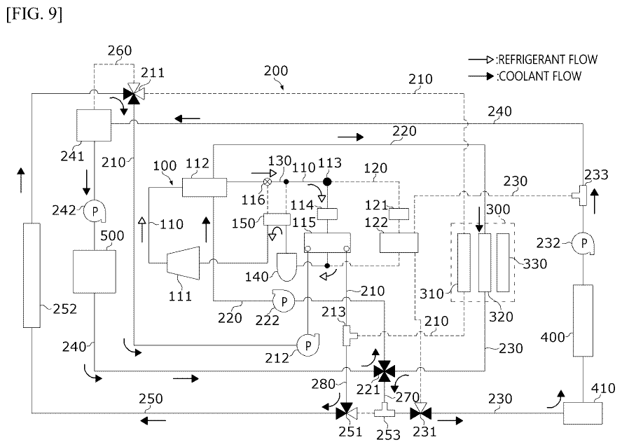

FIG. 9 is a view illustrating an operation in the sixth air conditioning mode.

Referring to FIG. 9, the sixth air conditioning mode is a mode in which the vehicle interior is heat, heat of the outside air is absorbed, and a temperature of the battery 400 is increased.

The operation of the refrigerant circulation line 100 in the sixth air conditioning mode is substantially identical to that in the first air conditioning mode. That is, the refrigerant may move along the first refrigerant line 110, and the flow of the refrigerant through the second refrigerant line 120 may be blocked in the state in which the second expansion valve 121 is closed. However, there is a difference in that the branch valve 116 allows the refrigerant to flow along the bypass line 130 and bypass the internal heat exchanger 150 without passing through the internal heat exchanger 150. Therefore, a specific description will be omitted.

The coolant in the coolant circulation line 200 is circulated by the operations of the first pump 212, the second pump 222, and the fourth pump 242. Further, the circulating coolant may exchange heat with the electrical component 500 and the battery 400 and the refrigerant passing through the condenser 112 and the first heat exchanger 115, and the circulating coolant may exchange heat with the outside air in the radiator 252.

In this case, the first direction switching valve 211 may be adjusted in the direction in which the first direction switching valve 211 branches off from the fourth coolant line 240 and connects the first coolant line 210 and the fifth coolant line 250. In addition, the second direction switching valve 221 may be adjusted in the direction in which the second direction switching valve 221 connects the second coolant line 220 to the fourth coolant line 240 and connects the second coolant line 220 to the fifth coolant line 250. In addition, the third direction switching valve 231 may be adjusted in the direction in which the third direction switching valve 231 connects the third coolant line 230 and the fifth coolant line 250, and the fourth direction switching valve 251 may be adjusted in the direction in which the fourth direction switching valve 251 connects the first coolant line 210 and the fifth coolant line 250.

More specifically, the coolant may flow as the left side and the lower side of the first direction switching valve 211 are connected to each other, and the right side and the upper side of the first direction switching valve 211 may be disconnected. The coolant may flow as the left side and the upper side of the second direction switching valve 221 are connected to each other, and the coolant may flow as the right side and the lower side of the second direction switching valve 221 are connected to each other. The coolant may flow as the left side and the right side of the third direction switching valve 231 are connected to each other, and the upper side of the third direction switching valve 231 may be disconnected. The coolant may flow as the left side and the upper side of the fourth direction switching valve 251 are connected to each other, and the right side of the fourth direction switching valve 251 may be disconnected.

Therefore, the coolant from the radiator 252 may move from the first direction switching valve 211 to the first coolant line 210, move to the third connection line 280 via the first heat exchanger 115 and the first branch valve 213, and flow into the fifth coolant line 250 from the fourth direction switching valve 251. Further, the coolant in the fifth coolant line 250 is introduced back into the radiator 252, such that the cycle for circulating the coolant is repeated.

In addition, the coolant may be introduced into the second coolant line 220 from the second direction switching valve 221 via the reservoir tank 241 and the electrical component 500 along the fourth coolant line 240, introduced back into the second connection line 270 from the second direction switching valve 221 via the condenser 112 and the heater core 320, and introduced into the third coolant line 230 via the third branch valve 253 and the third direction switching valve 231. Further, the coolant in the third coolant line 230 moves along the fourth coolant line 240 from the second branch valve 233 via the coolant heater 410 and the battery 400 and flows back into the reservoir tank 241, such that the cycle for circulating the coolant is repaired. In this case, the coolant heated by the operation of the coolant heater 410 may be supplied to the battery 400.

Therefore, the coolant exchanges heat with the air of the air conditioning device 300 while passing through the condenser 112 and the heater core 320, and the air is heated. The heated air may be supplied to the vehicle interior and heat the vehicle interior. In this case, the condenser 112 may be configured to recover and absorb waste heat of the electrical component 500, such that the vehicle interior and the battery 400 may be heated by using the heated coolant. As necessary, the coolant heated by the operation of the coolant heater 410 may further heat the battery 400, which may quickly improve the initial performance of the battery 400 in the winter season.

In addition, the first heat exchanger 115 is configured to absorb heat from the outside air through the radiator 252. Therefore, the first heat exchanger 115 and the condenser 112 may absorb heat from the different heat sources, which may improve the heating performance.

### 7. Seventh Air Conditioning Mode

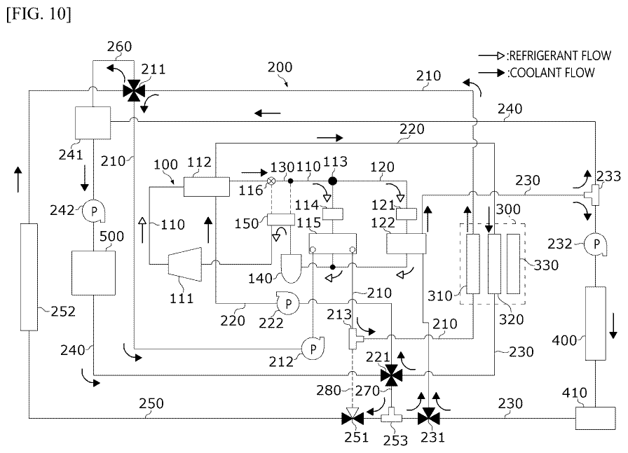

FIG. 10 is a view illustrating an operation in the seventh air conditioning mode.

With reference to FIG. 10, the seventh air conditioning mode refers to a mode in which dehumidification is performed, heat of the outside air is absorbed, and waste heat of the electrical component 500 and the battery 400 is absorbed by the second heat exchanger 122.

Because the operation of the refrigerant circulation line 100 in the seventh air conditioning mode is identical to that in the third air conditioning mode, a description thereof will be omitted.

The coolant in the coolant circulation line 200 is circulated by the operations of the first pump 212, the second pump 222, and the fourth pump 242. Further, the circulating coolant may exchange heat with the electrical component 500 and the battery 400 and the refrigerant passing through the condenser 112, the first heat exchanger 115, and the second heat exchanger 122, and the circulating coolant may exchange heat with the outside air in the radiator 252.

In this case, the first direction switching valve 211 may be adjusted in the direction in which the first direction switching valve 211 branches off from the first coolant line 210 and connects the fourth coolant line 240 and the fifth coolant line 250. In addition, the second direction switching valve 221 may be adjusted in the direction in which the second direction switching valve 221 branches off from the second coolant line 220 and connects the fourth coolant line 240 to the fifth coolant line 250. In addition, the third direction switching valve 231 may be adjusted in the direction in which the third direction switching valve 231 connects the third coolant line 230 and the fifth coolant line 250, and the fourth direction switching valve 251 may be adjusted to be disconnected from the first coolant line 210.

More specifically, the coolant may flow as the left side and the upper side of the first direction switching valve 211 are connected to each other, and the coolant may flow as the right side and the lower side of the first direction switching valve 211 are connected to each other. The coolant may flow as the left side and the lower side of the second direction switching valve 221 are connected to each other, and the coolant may flow as the right side and the upper side of the second direction switching valve 221 are connected to each other. The coolant may flow as the left side and the right side of the third direction switching valve 231 are connected to the upper side of the third direction switching valve 231. The coolant may flow as the left side and the right side of the fourth direction switching valve 251 are connected to each other, and the upper side of the fourth direction switching valve 251 may be disconnected.

Therefore, the coolant is introduced into the reservoir tank 241 from the radiator 252 via the first direction switching valve 211 and the first connection line 260. The coolant in the reservoir tank 241 moves along the fourth coolant line 240 and flows into the third branch valve 253 along the second connection line 270 from the second direction switching valve 221 via the electrical component 500. A part of the coolant branching off from the third branch valve 253 toward one side is introduced back into the radiator 252 via the fourth direction switching valve 251, such that the cycle for circulating the coolant may be repeated.

In addition, the remaining part of the coolant branching off from the third branch valve 253 toward the other side is introduced into the third coolant line 230 from the third direction switching valve 231 and introduced into the second branch valve 233 via the second heat exchanger 122. A part of the coolant branching off from the second branch valve 233 merges back into the third direction switching valve 231 along the third coolant line 230 via the battery 400 and the coolant heater 410, such that the cycle for circulating the coolant in the closed loop structure may be repeated. Further, the remaining part of the coolant branching off from the second branch valve 233 toward the other side merges back into the reservoir tank 241 along the fourth coolant line 240, such that the cycle for circulating the coolant may be repeated.

In addition, the coolant is introduced back into the cabin cooler 310 sequentially via the first direction switching valve 211, the first heat exchanger 115, and the first branch valve 213 from the cabin cooler 310 along the first coolant line 210, such that the cycle for circulating the coolant in a closed loop structure is repeated.

In addition, the coolant is introduced back into the heater core 320 sequentially via the second direction switching valve 221 and the condenser 112 from the heater core 320 along the second coolant line 220, such that the cycle for circulating the coolant in the closed loop structure is repeated.

Therefore, the coolant exchanges heat with the air of the air conditioning device 300 while passing through the first heat exchanger 115 and the cabin cooler 310, and the air is cooled. The cooled air may be supplied to the vehicle interior, such that the dehumidification may be performed in an interior cooling mode. That is, moisture in the air may be removed as the coolant exchanges heat with the air.

In addition, the second heat exchanger 122 is configured to absorb heat from the outside air through the radiator 252 and recover and absorb waste heat of the battery 400 and the electrical component 500 simultaneously, thereby improving the heating performance.

### 8. Eighth Air Conditioning Mode

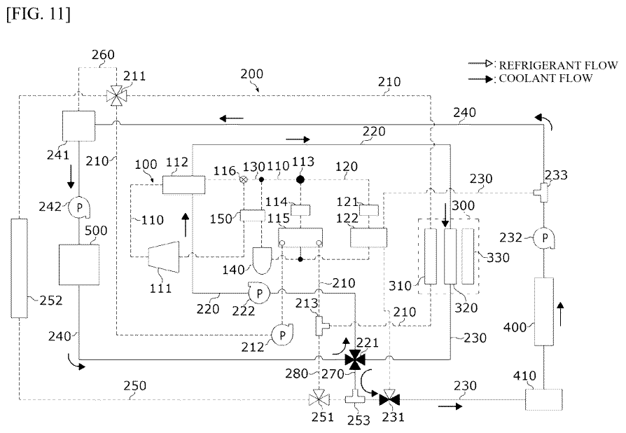

FIG. 11 is a view illustrating an operation in the eighth air conditioning mode.

With reference to FIG. 11, the eighth air conditioning mode refers to a mode in which the vehicle interior is heated by using waste heat of the electrical component 500 and the battery 400.

In the eighth air conditioning mode, the operation of the refrigerant circulation line 100 is stopped.

The coolant in the coolant circulation line 200 is circulated by the operations of the second pump 222 and the fourth pump 242. Further, the circulating coolant may exchange heat with the electrical component 500 and the battery 400.

In this case, the second direction switching valve 221 may be adjusted in the direction in which the second direction switching valve 221 connects the fourth coolant line 240 to the second coolant line 220 and connects the second coolant line 220 to the fifth coolant line 250. In addition, the third direction switching valve 231 may be adjusted in the direction in which the third direction switching valve 231 connects the third coolant line 230 and the fifth coolant line 250.

More specifically, the coolant may flow as the left side and the upper side of the second direction switching valve 221 are connected to each other, and the coolant may flow as the right side and the lower side of the second direction switching valve 221 are connected to each other. The coolant may flow as the left side and the right side of the third direction switching valve 231 are connected to each other, and the upper side of the third direction switching valve 231 may be disconnected.

Therefore, the coolant moves along the fourth coolant line 240 from the reservoir tank 241, flows into the second direction switching valve 221 via the electrical component 500, circulates back to the second direction switching valve 221 from the second direction switching valve 221 along the second coolant line 220 via the condenser 112 and the heater core 320, and then flows into the third coolant line 230 via the second connection line 270, the third branch valve 253, and the third direction switching valve 231.

The coolant in the third coolant line 230 flows into the second branch valve 233 via the coolant heater 410 and the battery 400, moves along the fourth coolant line 240 from the second branch valve 233, and flows back into the reservoir tank 241, such that the cycle for circulating the coolant may be repaired.

Therefore, the coolant may recover waste heat of the electrical component 500 and waste heat of the battery 400 while passing through the electrical component 500 and the battery 400, thereby heating the vehicle interior.

While the present invention has been described above with reference to the exemplary embodiments, it may be understood by those skilled in the art that the present invention may be variously modified and changed without departing from the spirit and scope of the present invention disclosed in the claims. Further, it should be interpreted that the differences related to the modifications and alterations are included in the scope of the present invention defined by the appended claims.

1. A thermal management system for a vehicle, the thermal management system comprising:
a compressor;
a condenser;
a refrigerant branch part;
a first refrigerant line branching off from the refrigerant branch part toward one side, provided with a first expansion valve and a first heat exchanger, and configured to allow a refrigerant to circulate therethrough;
a second refrigerant line branching off from the refrigerant branch part toward the other side, provided with a second expansion valve and a second heat exchanger, and configured to allow a refrigerant to circulate therethrough;
an internal heat exchanger configured to allow the refrigerant, which passes through the condenser and moves to the refrigerant branch part, and the refrigerant, which passes through the first heat exchanger or the second heat exchanger and moves to the compressor, to exchange heat with each other; and
a bypass line connected to allow the refrigerant having passed through the condenser to bypass the internal heat exchanger.

2. The thermal management system of claim 1, further comprising:
a branch valve disposed at an outlet side of the condenser,
wherein depending on an air conditioning mode, the branch valve allows the refrigerant to pass through the internal heat exchanger or allows the refrigerant to move to the bypass line and bypass the internal heat exchanger.

3. The thermal management system of claim 1, further comprising:
an accumulator configured to separate the refrigerant, which passes through the first heat exchanger or the second heat exchanger and moves to the compressor, into a gaseous refrigerant and a liquid refrigerant and supply the gaseous refrigerant to the compressor.

4. The thermal management system of claim 3, wherein the accumulator is integrated with the internal heat exchanger.

5. The thermal management system of claim 1, further comprising:
a coolant circulation line configured to circulate a coolant that exchanges heat with air or the refrigerant.

6. The thermal management system of claim 5, wherein the coolant circulation line comprises:
a first coolant line configured to exchange heat with the refrigerant while passing through the first heat exchanger and provided with a cabin cooler and a first direction switching valve;
a second coolant line provided with a second direction switching valve and a heater core configured to heat a vehicle interior by using the coolant having exchanged heat with the refrigerant while passing through the condenser; and
a third coolant line provided with a third direction switching valve and a battery through which the coolant having exchanged heat with the refrigerant while passing through the second heat exchanger flows.

7. The thermal management system of claim 6, further comprising:
a fourth coolant line connected to the second direction switching valve and branching off from the third coolant line connected to an outlet side of the second heat exchanger; and
a fifth coolant line configured to connect the first direction switching valve and the third direction switching valve.

8. The thermal management system of claim 7, wherein a reservoir tank and an electrical component are disposed in the fourth coolant line, and a fourth direction switching valve and a radiator are disposed in the fifth coolant line.

9. The thermal management system of claim 8, wherein the first direction switching valve is connected to a first connection line branching off from the reservoir tank, the second direction switching valve is connected to a second connection line branching off from the fifth coolant line, and the fourth direction switching valve is connected to a third connection line branching off from the first coolant line.

10. The thermal management system of claim 7, wherein pumps are respectively disposed in the first to fourth coolant lines, and a coolant heater is disposed in the third coolant line and selectively operates to heat the coolant depending on an operating mode.

11. The thermal management system of claim 6, wherein the cabin cooler and the heater core are installed in an air conditioning device, and a PTC heater is further installed in the air conditioning device.

12. The thermal management system of claim 2, wherein in a cooling mode, the branch valve controls the refrigerant so that the refrigerant moves along a first refrigerant line and passes through the internal heat exchanger.

13. The thermal management system of claim 2, wherein in a heating mode, the branch valve controls the refrigerant so that the refrigerant moves to the bypass line and bypasses the internal heat exchanger.
